(19) United States
(12) Patent Application Publication
(10) Pub. No.: US 2025/0346294 A1
(43) Pub. Date: Nov. 13, 2025

(54) CONTROL DEVICE AND LANE KEEPING SYSTEM

(71) Applicant: NIDEC CORPORATION, Kyoto (JP)

(72) Inventors: Shuji ENDO, Kyoto (JP); Daisuke NOTSU, Kyoto (JP); Tang CHUANJUN, Suzhou City (CN)

(21) Appl. No.: 18/719,874

(22) PCT Filed: Dec. 14, 2022
(86) PCT No.: PCT/JP2022/045969

§ 371 Date: Dec. 11, 2024

Related U.S. Application Data
(60) Provisional application No. 63/290,127, filed on Dec. 16, 2021.

(51) Int. Cl. B62D 15/02; B62D 5/04

(52) U.S. Cl. CPC B62D 15/025; B62D 5/0463

(57) ABSTRACT

One aspect of a control device of the present invention is a control device that includes a motor and controls the steering mechanism mounted on a vehicle. The control device includes an assist control unit that generates an instruction torque to be input to the motor. The assist control unit generates the instruction torque in consideration of a mechanical characteristic of an arm of a steering person.

This application claims priority based on U.S. Patent Application Ser. No. 63/290,127, filed on Dec. 16, 2021, the contents of which are incorporated herein by reference.

### TECHNICAL FIELD

The present invention relates to a control device and a lane keeping system.

### BACKGROUND ART

An electric power steering system mounted on a vehicle is known. For example, an electric power steering system described in Patent Literature 1 includes a control device including a disturbance observer that estimates a disturbance torque.

### CITATIONS LIST

### Patent Literature

Patent Literature 1: JP 2018-183046 A

### SUMMARY OF INVENTION

### Technical Problems

The electric power steering system as described above is used, for example, in a lane keeping system. The lane keeping system provides a driving force to the steering mechanism by the motor to keep the vehicle in the lane when the vehicle is likely to deviate from the lane. In a conventional lane keeping system, PI control is used in which a deviation between a target steering angle, that is, an angle of a steering wheel, and a current steering angle is calculated, and a steering torque given to a steering mechanism by a motor is determined on the basis of the deviation.

Here, when an actual vehicle is driven, for example, as illustrated in FIG. 11, the steering person who steers the steering wheel changes the angular frequency response characteristics of his/her arm holding the steering wheel in accordance with the characteristics of the vehicle and the characteristics of the electric power steering system. FIG. 11 is a Bode diagram illustrating the angular frequency response characteristics of the muscles of the arm of the steering person. In FIG. 11, the horizontal axis represents the frequency f [Hz], and the vertical axis represents the gain [dB]. In FIG. 11, a gain curve G4a indicates a gain characteristic in a case where the arm of the steering person is in a relaxed state. In FIG. 11, a gain curve G4b indicates a gain characteristic in a case where the arm of the steering person is in a tense state. For example, the steering person unconsciously performs control to maintain a target steering angle by changing the angular frequency response characteristics of the arm in accordance with the magnitude of the disturbance torque input to the steering wheel. In the conventional lane keeping system, the driving force, that is, the steering torque, is applied to the steering mechanism by the motor without considering the mechanical characteristics of the arm of the steering person such as changing the angular frequency response characteristics. Therefore, there has been a case where the driving force applied from the motor to the steering mechanism gives a sense of discomfort to a steering person who steers the steering wheel of the vehicle.

In view of the above circumstances, an object of the present invention is to provide a control device that controls a steering mechanism mounted on a vehicle and is capable of reducing the sense of discomfort given to a steering person, and a lane keeping system.

### Solution to Problems

One aspect of a control device of the present invention is a control device that includes a motor and controls a steering mechanism mounted on a vehicle. The control device includes an assist control unit that generates an instruction torque to be input to the motor. The assist control unit generates the instruction torque in consideration of a mechanical characteristic of an arm of a steering person.

One aspect of a lane keeping system of the present invention includes an imaging device that images a lane, and the control device.

### Advantageous Effects of Invention

According to one aspect of the present invention, when the control device controls the steering mechanism, it is possible to reduce a sense of discomfort given to the steering person.

### BRIEF DESCRIPTION OF DRAWINGS

FIG. 1 is a block diagram illustrating a configuration of a lane keeping system according to a first embodiment.

FIG. 2 is a diagram schematically illustrating a case where a vehicle including the lane keeping system according to the first embodiment travels in a lane.

FIG. 3 is a diagram schematically illustrating an electric power steering device according to the first embodiment.

FIG. 4 is a block diagram illustrating a configuration of a steering control unit according to the first embodiment.

FIG. 5A is a Bode diagram illustrating a gain characteristic in the vehicle characteristics based on the relationship between the steering angle and the yaw rate of a vehicle.

FIG. 5B is a Bode diagram illustrating a phase characteristic in the vehicle characteristics based on the relationship between the steering angle and the yaw rate of the vehicle.

FIG. 6A is a diagram illustrating frequency characteristics of a steering angle and a steering torque when a steering person steers a steering wheel in a case where there is no control by an assist control unit, which is a Bode diagram illustrating gain characteristics.

FIG. 6B is a diagram illustrating frequency characteristics of a steering angle and a steering torque when a steering person steers the steering wheel in a case where there is no control by an assist control unit, which is a Bode diagram illustrating phase characteristics.

FIG. 7 is a block diagram illustrating a configuration of a lane keeping system according to a second embodiment.

FIG. 8 is a block diagram illustrating a configuration of a lane keeping system according to a third embodiment.

FIG. 9A is a graph illustrating a result of actual vehicle measurement in a case where a vehicle characteristic compensation unit is not provided.

FIG. 9B is a graph illustrating a result of actual vehicle measurement in a case where a vehicle characteristic compensation unit is provided.

FIG. 10A is a diagram illustrating frequency characteristics in an example, which is a Bode diagram illustrating gain characteristics.

FIG. 10B is a diagram illustrating frequency characteristics in an example, which is a Bode diagram illustrating phase characteristics.

FIG. 11 is a Bode diagram illustrating angular frequency response characteristics of muscles of an arm of a steering person.

### DESCRIPTION OF EMBODIMENTS

### First Embodiment

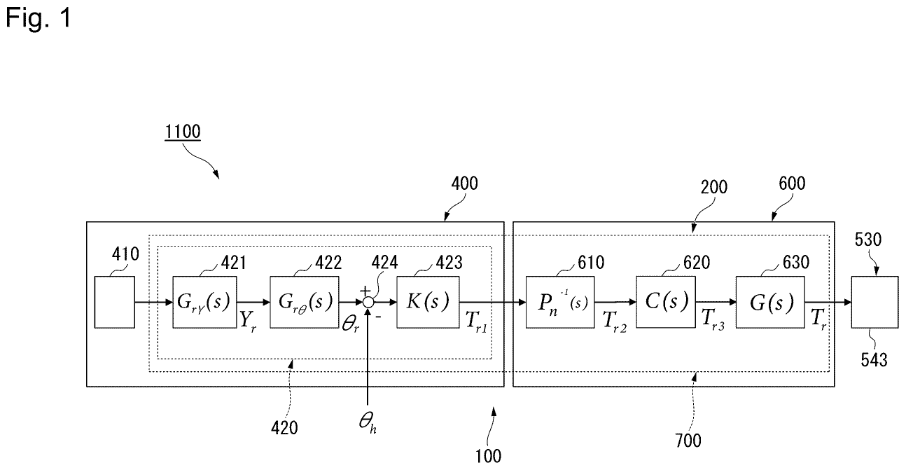

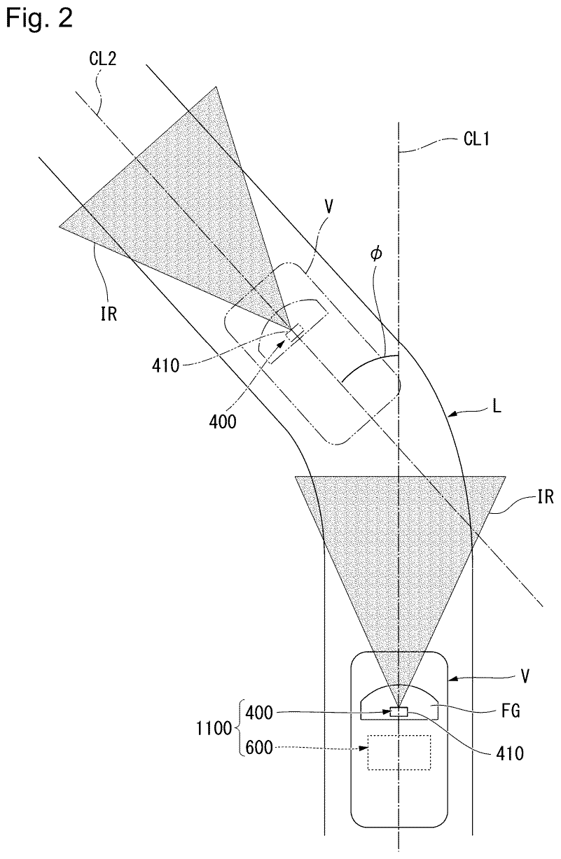

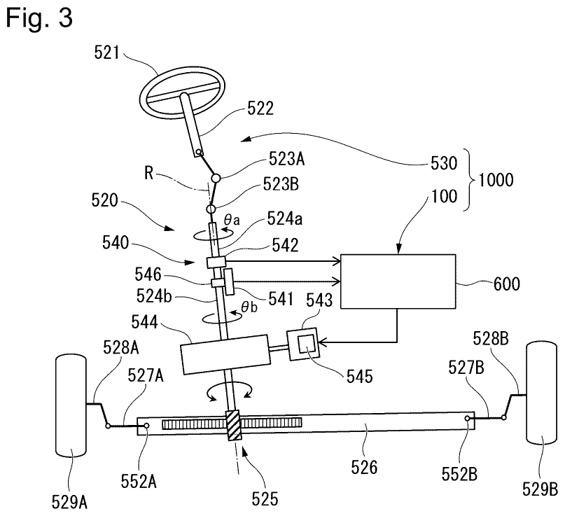

A lane keeping system 1100 of the present embodiment illustrated in FIG. 1 is a system for keeping a vehicle V driven by a human at the center of a lane L. As illustrated in FIG. 1, the lane keeping system 1100 includes an imaging device 410 that images the lane L, and a control device 100 that controls a steering mechanism 530 mounted on the vehicle V on the basis of information obtained from the imaging device 410. As illustrated in FIG. 2, the lane keeping system 1100 images the front of the lane L on which the vehicle V travels, by the imaging device 410. When the vehicle V is about to deviate from the center of the lane L based on the image of the lane L captured by the imaging device 410, the lane keeping system 1100 controls the steering mechanism 530 by the control device 100 to return the vehicle V to the position at the center of the lane L. As illustrated in FIG. 3, the steering mechanism 530 and the control device 100 constitute an electric power steering device 1000 mounted on the vehicle V.

The steering mechanism 530 includes a steering mechanism unit 520 and an auxiliary mechanism unit 540. The electric power steering device 1000 controls the auxiliary mechanism unit 540 by the control device 100 to generate an auxiliary torque that assists the steering torque Tₕ generated in the steering mechanism unit 520 when the driver who drives the vehicle V steers the steering wheel 521. The auxiliary torque reduces the burden of the driver's operation when the driver operates the steering wheel 521. The driver of the vehicle V is a steering person who steers the steering wheel 521 of the vehicle V.

The steering mechanism unit 520 includes the steering wheel 521, a steering shaft 522, universal joints 523A and 523B, an input shaft 524a, an output shaft 524b, a rack and pinion mechanism 525, a rack shaft 526, right and left ball joints 552A and 552B, tie rods 527A and 527B, knuckles 528A and 528B, and right and left steered wheels 529A and 529B.

The steering shaft 522 is a shaft extending from the steering wheel 521 steered by a steering person. One end portion of the input shaft 524a is connected to an end portion of the steering shaft 522 on a side opposite to a side connected to the steering wheel 521 via the universal joints 523A and 523B. As a result, the steering wheel 521 is connected to the input shaft 524a via the universal joints 523A and 523B and the steering shaft 522. The output shaft 524b is connected to the input shaft 524a via a torsion bar 546 described later. More specifically, one end portion of the output shaft 524b is connected to the other end portion of the input shaft 524a via the torsion bar 546. The other end portion of the output shaft 524b is connected to the rack shaft 526 via the rack and pinion mechanism 525.

The input shaft 524a and the output shaft 524b are coaxially disposed. The input shaft 524a and the output shaft 524b are rotatable about the same central axis. The input shaft 524a and the output shaft 524b are relatively rotatable with respect to each other in a range in which a torsion bar 546 described later can be twisted.

The auxiliary mechanism unit 540 includes a steering torque sensor 541, a steering angle sensor 542, a motor 543, a deceleration mechanism 544, an inverter 545, and the torsion bar 546. That is, the steering mechanism 530 includes the motor 543. The torsion bar 546 connects the input shaft 524a and the output shaft 524b. The torsion bar 546 is disposed coaxially with the input shaft 524a and the output shaft 524b. In the following description, a virtual axis passing through a common central axis of the input shaft 524a, the output shaft 524b, and the torsion bar 546 is referred to as a rotation axis R. The torsion bar 546 can be twisted around the rotation axis R.

The steering torque sensor 541 detects steering torque Tₕ in the steering mechanism unit 520 by detecting the amount of torsion around the rotation axis R of the torsion bar 546. The steering torque Tₕ is torsion bar torque generated in the torsion bar 546, and is a torsional moment around the rotation axis R. The steering angle sensor 542 can detect a rotation angle θa around the rotation axis R of the input shaft 524a. The rotation angle θa of the input shaft 524a is equal to the steering angle of the steering wheel 521. That is, the steering angle sensor 542 can detect the steering angle of the steering wheel 521 by detecting the rotation angle θa of the input shaft 524a. A rotation angle θb of the output shaft 524b can be detected based on the steering torque sensor 541 and the steering angle sensor 542.

The inverter 545 converts direct-current power into three-phase AC power having U-phase, V-phase, and W-phase pseudo sine waves in accordance with the motor driving signal input from the control device 100, and supplies the power to the motor 543. The motor 543 is connected to the output shaft 524b via the deceleration mechanism 544. The three-phase AC power is supplied from the inverter 545 to the motor 543. The motor 543 is, for example, an interior permanent magnet synchronous motor (IPMSM), a surface permanent magnet synchronous motor (SPMSM), or a switched reluctance motor (SRM). When the three-phase AC power is supplied from the inverter 545, the motor 543 generates an auxiliary torque according to an instruction torque Tᵣ to be described later. The motor 543 transmits the generated auxiliary torque to the output shaft 524b via the deceleration mechanism 544.

As illustrated in FIG. 1, the control device 100 includes an assist control unit 700 that generates instruction torque Tᵣ input to the motor 543. In the present embodiment, the assist control unit 700 can execute lane keeping control for generating the instruction torque Tᵣ so as to keep the vehicle V on which the steering mechanism 530 is mounted in the lane L. For example, the assist control unit 700 always executes the lane keeping control when the vehicle V travels. The lane keeping control is executed by the assist control unit 700, and the directions of the steered wheels 529A and 529B are adjusted by the driving force transmitted from the motor 543 to the output shaft 524b, so that the vehicle V is suppressed from deviating from the lane L. In the lane keeping control of the present embodiment, the assist control unit 700 generates the instruction torque Tᵣ so as to keep the vehicle V at the center in the width direction of the lane L. Note that control performed by the assist control unit 700 will be described below as at least control performed in the lane keeping control unless otherwise specified.

In the lane keeping control, the assist control unit 700 generates the instruction torque Tᵣ in consideration of the mechanical characteristics of the arm of a steering person who steers the steering wheel 521. “The assist control unit 700 generates the instruction torque Tᵣ in consideration of the mechanical characteristics of the arm of a steering person” means that, for example, the assist control unit 700 may calculate the instruction torque Tᵣ directly or indirectly based on the parameter related to the input applied to the steering wheel 521 from the arm of the steering person. “Calculating the instruction torque Tᵣ indirectly based on the parameter” includes calculating the instruction torque Tᵣ by an expression determined based on the actual parameter. In the present embodiment, the assist control unit 700 calculates the instruction torque Tᵣ on the basis of an expression determined on the basis of the response characteristic of the output with respect to the input applied to the steering wheel 521 from the arm of the steering person when the vehicle V travels.

The assist control unit 700 includes an imaging device controller 420, a vehicle characteristic compensation unit 610, a correction unit 620, and a steering controller 630. The imaging device 410 and the imaging device controller 420 constitute an imaging unit 400. The vehicle characteristic compensation unit 610, the correction unit 620, and the steering controller 630 constitute a steering control unit 600. In the present embodiment, the lane keeping system 1100 includes the imaging unit 400 and the steering control unit 600.

The steering control unit 600 controls the steering mechanism 530. The steering control unit 600 is electrically connected to the inverter 545. The steering control unit 600 generates a motor driving signal based on the detection signals detected by the steering torque sensor 541, the steering angle sensor 542, a vehicle speed sensor 300 mounted on the vehicle V, and the like, and outputs the motor driving signal to the inverter 545. The steering control unit 600 controls the steering mechanism 530 by controlling the rotation of the motor 543 via the inverter 545. More specifically, the steering control unit 600 controls the switching operation of a plurality of switching elements included in the inverter 545. Specifically, the steering control unit 600 generates a control signal for controlling the switching operation of each switching element and outputs the control signal to the inverter 545. Each switching element is, for example, a metal oxide semiconductor field effect transistor (MOSFET). In the following description, a control signal for controlling the switching operation of each switching element is referred to as a “gate control signal”.

The steering control unit 600 generates a torque command value on the basis of the steering torque Tₕ or the like, and controls the torque of the motor 543 and the rotational speed of the motor 543 by vector control, for example. The vector control is a method in which current flowing through the motor 543 is separated into a current component that contributes to generation of torque and a current component that contributes to generation of a magnetic flux, and the current components orthogonal to each other are independently controlled. The steering control unit 600 can perform not only vector control but also other closed-loop control.

Note that the value of the steering torque Tₕ may be directly input to the steering control unit 600 from the steering torque sensor 541, or the steering control unit 600 may calculate the value of the steering torque Tₕ from the output value of the steering torque sensor 541. The value of the steering angle θₕ of the steering wheel 521 may be directly input to the steering control unit 600 from the steering angle sensor 542, or the steering control unit 600 may calculate the value of the steering angle θₕ from the output value of the steering angle sensor 542.

The steering control unit 600 and the motor 543 are modularized, and are manufactured and sold as a motor module. The motor module includes the motor 543 and the steering control unit 600, and is suitably used for the electric power steering device 1000. The steering control unit 600 can be manufactured and sold as a control device for controlling the electric power steering device 1000 independently of the motor 543.

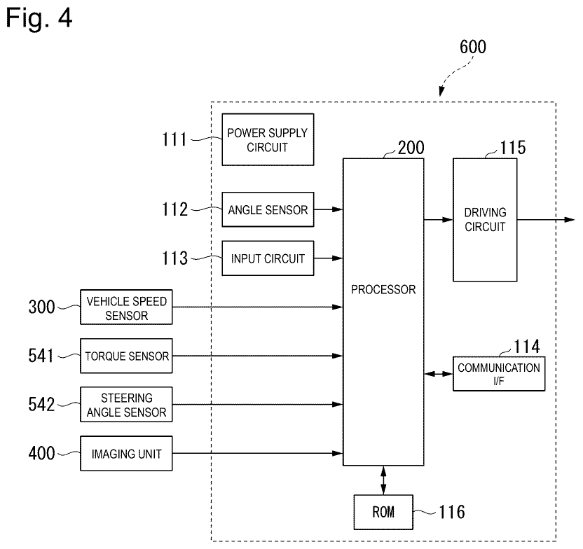

FIG. 4 illustrates a typical example of the configuration of the steering control unit 600 according to the present embodiment. The steering control unit 600 includes, for example, a power supply circuit 111, an angle sensor 112, an input circuit 113, a communication I/F 114, a driving circuit 115, a ROM 116, and a processor 200. The steering control unit 600 can be realized as a printed circuit board (PCB) on which these electronic components are mounted.

The vehicle speed sensor 300, the steering torque sensor 541, the steering angle sensor 542, and the imaging unit 400, mounted on the vehicle V, are communicably connected to the processor 200. A vehicle speed is transmitted from the vehicle speed sensor 300 to the processor 200. The steering torque Tₕ is transmitted from the steering torque sensor 541 to the processor 200. The steering angle θₕ is transmitted from the steering angle sensor 542 to the processor 200. Target torque Tᵣ₁, to be described later, is transmitted from the imaging unit 400 to the processor 200.

The processor 200 is a semiconductor integrated circuit, and is also referred to as a central processing unit (CPU) or a microprocessor. The processor 200 sequentially executes computer programs which are stored in the ROM 116 and describe commands for controlling motor driving, and realizes desired processing. In addition to the processor 200 or instead of the processor 200, the control device 100 may include a field programmable gate array (FPGA) equipped with a CPU, a graphics processing unit (GPU), an application specific integrated circuit (ASIC), an application specific standard product (ASSP), or a combination of two or more circuits selected from these circuits. The processor 200 sets a current command value according to the actual current value, the rotation angle of the rotor, and the like of the motor 543, generates a pulse width modulation (PWM) signal, and outputs the PWM signal to the driving circuit 115.

The power supply circuit 111 is connected to an external power source (not illustrated). The power supply circuit 111 generates a DC voltage necessary for each unit of the control device 100. The DC voltage generated in the power supply circuit 111 is, for example, 3 V or 5 V.

The angle sensor 112 detects a rotation angle of the rotor in the motor 543, and outputs the rotation angle to the processor 200. The angle sensor 112 may be a resolver, a Hall element such as a Hall IC, or an MR sensor having a magnetoresistive element. The processor 200 can calculate an angular velocity ω [rad/s] of the motor 543 based on an electrical angle θm of the motor 543 obtained based on the angle sensor 112. The control device 100 may include, instead of the angle sensor 112, a speed sensor capable of detecting the rotational angular velocity of the motor 543 and an acceleration sensor capable of detecting the rotational angular acceleration of the motor 543.

A motor current value detected by a current sensor (not illustrated) is input to the input circuit 113. In the following description, a motor current value detected by a current sensor (not illustrated) is referred to as an “actual current value”. The input circuit 113 converts the level of the input actual current value into an input level of the processor 200 as necessary, and outputs the actual current value to the processor 200. A typical example of the input circuit 113 is an analog-digital conversion circuit.

The communication I/F 114 is an input/output interface for transmitting/receiving data in conformity with an in-vehicle control area network (CAN), for example.

The driving circuit 115 is typically a gate driver or a pre-driver. The driving circuit 115 generates a gate control signal in accordance with the PWM signal, and gives the gate control signal to gates of a plurality of switching elements included in the inverter 545. For example, when the motor 543 to be driven is a motor that can be driven at a low voltage, the driving circuit 115 as a gate driver is not necessarily required in some cases. In that case, the function of the gate driver in the driving circuit 115 may be implemented in the processor 200.

The ROM 116 is electrically connected to the processor 200. The ROM 116 is a writable memory, a rewritable memory, or a read-only memory, for example. Examples of the writable memory include a programmable read only memory (PROM). Examples of the rewritable memory include a flash memory, an electrically erasable programmable read only memory (EEPROM), and the like. The ROM 116 stores therein a control program including commands for causing the processor 200 to control motor driving. For example, the control program stored in the ROM 116 is once developed in a RAM (not illustrated) at the time of booting.

FIG. 1 illustrates examples of functional blocks of the processor 200 of this embodiment. The processor 200, which is a computer, sequentially executes processing or tasks necessary for controlling the motor 543 using each functional block. Each functional block of the processor 200 illustrated in FIG. 1 may be implemented in the processor 200 as software such as firmware, may be implemented in the processor 200 as hardware, or may be implemented in the processor 200 as software and hardware. The processing of each functional block in the processor 200 is typically described in a computer program in units of software modules and stored in the ROM 116. However, in the case where an FPGA or the like is used, all or some of the functional blocks may be implemented as hardware accelerators. In addition, the method of controlling the control device 100 according to the present embodiment is implemented in a computer, and can be implemented by causing the computer to execute a desired operation. In the present embodiment, the functional blocks of the processor 200 include the vehicle characteristic compensation unit 610, the correction unit 620, and the steering controller 630.

As illustrated in FIG. 2, the imaging unit 400 is attached to, for example, a windshield FG of a vehicle V. The imaging device 410 images a portion of the lane L located in front of the vehicle V. The imaging device 410 is, for example, a camera having a CCD image sensor. The imaging device controller 420 controls the imaging device 410. Similarly to the processor 200, the imaging device controller 420 is a semiconductor integrated circuit. FIG. 1 illustrates examples of functional blocks of the imaging device controller 420. The imaging device controller 420, which is a computer, sequentially executes processing or tasks necessary for controlling the imaging device 410 using each functional block. Each functional block of the imaging device controller 420 illustrated in FIG. 1 may be implemented in the imaging device controller 420 as software such as firmware, may be implemented in the imaging device controller 420 as hardware, or may be implemented in the imaging device controller 420 as software and hardware. The processing of each functional block in the imaging device controller 420 is typically described in a computer program in units of software modules and stored in a memory. However, in the case where an FPGA or the like is used as the imaging device controller 420, all or some of the functional blocks may be implemented as hardware accelerators. As illustrated in FIG. 1, the imaging device controller 420 includes a yaw rate calculation unit 421, a steering angle calculation unit 422, a torque calculation unit 423, and a subtractor 424 as functional blocks.

The yaw rate calculation unit 421 calculates a target yaw rate Yᵣ on the basis of the image information input from the imaging device 410. Here, the yaw rate Y in the vehicle V is a parameter indicating a change in the yaw angle φ which is a deflection angle in the left-right direction of the vehicle V. In other words, the yaw rate Y is an angular velocity when the vehicle V swings in the left-right direction. In the example illustrated in FIG. 2, in the lane L provided with a curve turning to the left, the vehicle V before turning the curve is indicated by a solid line, and the vehicle V after turning the curve is indicated by a two-dot chain line. An angle formed by an imaginary line CL1 extending in the traveling direction of the vehicle V indicated by a solid line and an imaginary line CL2 extending in the traveling direction of the vehicle V indicated by a two-dot chain line is a yaw angle (that has changed when the vehicle V turns the curve. Note that, for example, the imaginary lines CL1 and CL2 coincide with the optical axis of the imaging device 410 when viewed from the upper side in the vertical direction. The optical axis of the imaging device 410 passes through the center in the left-right direction of a region IR imaged by the imaging device 410. The yaw rate calculation unit 421 calculates, as the target yaw rate Yᵣ, a value of the yaw rate Y necessary for preventing the vehicle V from deviating from the lane L. As illustrated in FIG. 1, the target yaw rate Yᵣ calculated by the yaw rate calculation unit 421 is input to the steering angle calculation unit 422.

The steering angle calculation unit 422 calculates a target steering angle θᵣ based on the target yaw rate Yᵣ calculated by the yaw rate calculation unit 421. The target steering angle θᵣ is a steering angle θₕ of the steering wheel 521 necessary for setting the yaw rate Y to the target yaw rate Yᵣ, and is a steering angle θₕ of the steering wheel 521 necessary for preventing the vehicle V from deviating from the lane L. The target steering angle θᵣ calculated by the steering angle calculation unit 422 is input to the subtractor 424.

The current steering angle θₕ of the steering wheel 521 is input to the subtractor 424. The steering angle θₕ input to the subtractor 424 is transmitted from the processor 200. In the present embodiment, the processor 200 transmits the steering angle θₕ input from the steering angle sensor 542 to the subtractor 424 of the imaging device controller 420. The subtractor 424 subtracts the steering angle θₕ from the target steering angle θᵣ. The output from the subtractor 424 is input to the torque calculation unit 423.

The torque calculation unit 423 calculates the target torque Tᵣ₁ based on the difference between the target steering angle θᵣ input from the subtractor 424 and the current steering angle θₕ. The target torque Tᵣ₁ is a torque of the motor 543 required to set the steering angle θₕ to the target steering angle θᵣ. The target torque Tᵣ₁ calculated by the torque calculation unit 423 is input to the vehicle characteristic compensation unit 610 of the steering control unit 600.

The vehicle characteristic compensation unit 610 is a part that compensates for a vehicle characteristic based on the relationship between the steering angle θₕ and the yaw rate Y indicating the change in the yaw angle φ of the vehicle V on which the steering mechanism 530 is mounted. The vehicle characteristic is a transmission characteristic when the steering angle θₕ is input and the yaw rate Y is output. A transfer function P(s) of the vehicle characteristic is expressed by, for example, the following Expression [1].

$$[ Expression 1 ]$$

$$P ( s ) = \frac{gs + h}{k {s}^{2} + ms + r} \qquad [ 1 ]$$

Where, s represents a Laplace transducer, and g, h, k, m, and r represent coefficients relating to the vehicle characteristics. The coefficients g, h, k, and m are values determined for each vehicle, for example. Each of the coefficients g, h, k, and m changes depending on the speed of the vehicle, the steering torque Tₕ applied to the steering wheel 521 by the steering person, and the like, even in the same vehicle.

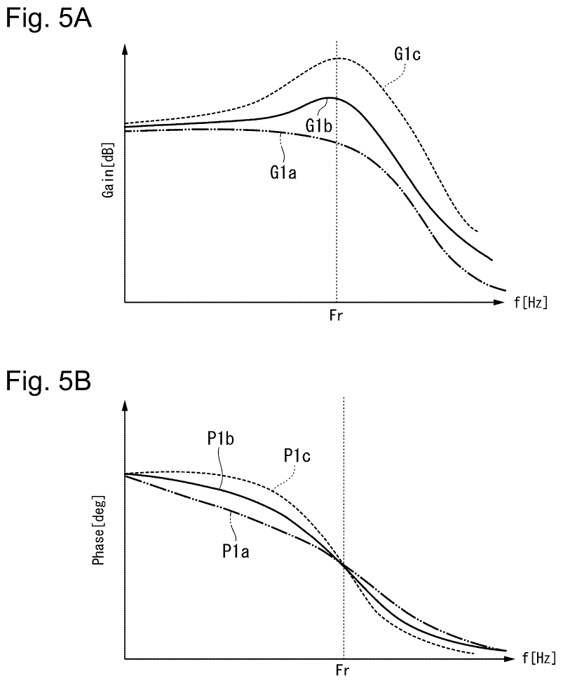

A gain [dB] of the vehicle characteristic changes, for example, as illustrated in the graph of FIG. 5A. In FIG. 5A, the horizontal axis represents the frequency f [Hz], and the vertical axis represents the gain [dB]. FIG. 5A is a Bode diagram illustrating a gain characteristic in the frequency characteristic of the vehicle V when the steering angle θₕ is input and the yaw rate Y is output. FIG. 5A illustrates a first gain curve G1a, a second gain curve G1b, and a third gain curve G1c. The speed of the vehicle V when the gain of the vehicle characteristic changes as indicated by a second gain curve G1b is higher than the speed of the vehicle V when the gain of the vehicle characteristic changes as indicated by a first gain curve G1a. The speed of the vehicle V when the gain of the vehicle characteristic changes as indicated by a third gain curve G1c is higher than the speed of the vehicle V when the gain of the vehicle characteristic changes as indicated by the second gain curve G1b.

The phase [deg] of the vehicle characteristic changes, for example, as illustrated in the graph of FIG. 5B. In FIG. 5B, the horizontal axis represents the frequency f [Hz], and the vertical axis represents the phase [deg]. FIG. 5B is a Bode diagram illustrating a phase characteristic in the frequency characteristic of the vehicle V when the steering angle θₕ is input and the yaw rate Y is output. FIG. 5B illustrates a first phase curve P1a, a second phase curve P1b, and a third phase curve P1c. The speed of the vehicle V when the phase of the vehicle characteristic changes as indicated by a second phase curve P1b is higher than the speed of the vehicle V when the phase of the vehicle characteristic changes as indicated by a first phase curve P1a. The speed of the vehicle V when the phase of the vehicle characteristic changes as indicated by a third phase curve P1c is higher than the speed of the vehicle V when the phase of the vehicle characteristic changes as indicated by the second phase curve P1b.

For example, the above Expression [1] is an expression obtained based on experimentally obtained vehicle characteristic of the vehicle V, and is an expression approximately representing the vehicle characteristic of the vehicle V. Therefore, the transfer function P(s) of the actual vehicle characteristic of the vehicle V may be strictly different from Expression [1]. Furthermore, depending on the type or the like of the vehicle V, the transfer function P(s) of the vehicle characteristic may be approximated by an expression different from Expression [1].

A transfer function Pₙ⁻¹(s) of the vehicle characteristic compensation unit 610 is a transfer function that cancels the vehicle characteristic expressed by Expression [1] described above. In the present embodiment, the transfer function Pₙ⁻¹(s) of the vehicle characteristic compensation unit 610 is expressed by the following Expression [2].

$$[ Expression 2 ]$$

$${P}_{n}^{- 1} ( s ) = \frac{{k}_{n} {s}^{2} + {m}_{n} s + {r}_{n}}{{g}_{n} s + {h}_{n}} \qquad [ 2 ]$$

Where, s represents a Laplace transducer, and gₙ, hₙ, kₙ, mₙ, and rₙ represent coefficients relating to the vehicle characteristics. The coefficients gₙ, hₙ, kₙ, mₙ, and rₙ are different values for each vehicle V, for example. Each of the coefficients gₙ, hₙ, kₙ, mₙ, and rₙ changes according to the speed of the vehicle V and a change in the steering torque Tₕ applied to the steering wheel 521 from the steering person. As a result, the transfer function Pₙ⁻¹(s) of the vehicle characteristic compensation unit 610 changes based on the speed of the vehicle V. The coefficients gₙ, hₙ, kₙ, mₙ, and rₙ have the same values as the coefficients g, h, k, m, and r in Expression [1], for example. As illustrated in FIG. 1, the target torque Tᵣ₁ input to the vehicle characteristic compensation unit 610 is corrected by the vehicle characteristic compensation unit 610, and is input to the correction unit 620 as a target torque Tᵣ₂.

The correction unit 620 is a unit that performs correction in consideration of the mechanical characteristics of the arm of the steering person. The correction unit 620 corrects the target torque obtained based on a signal from the imaging device 410 that images the lane L, that is, a target torque Tᵣ₂ output from the vehicle characteristic compensation unit 610. In the present embodiment, the correction unit 620 corrects the target torque Tᵣ₂ so as to approach the steering torque Tₕ when the steering person actually steers the steering wheel 521 in the case where there is no control by the assist control unit 700, and outputs the corrected target torque Tᵣ₂ as a target torque Tᵣ₃.

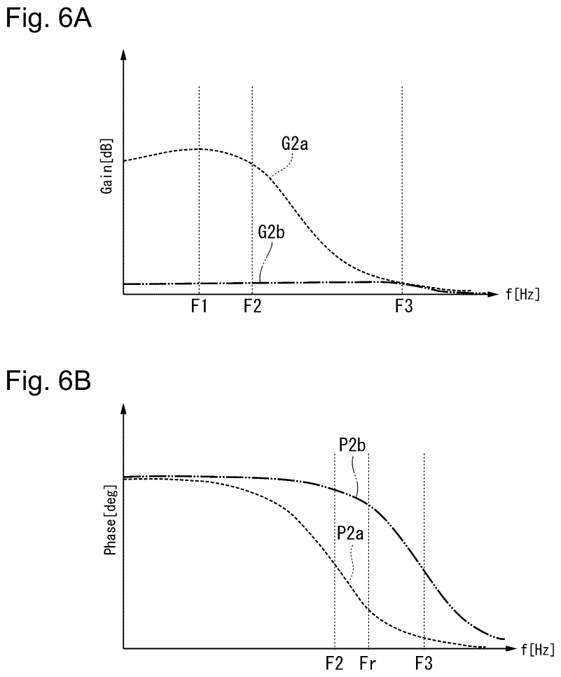

FIGS. 6A and 6B are graphs illustrating examples of frequency characteristics of the steering angle θₕ and the steering torque Tₕ when the steering person actually steers the steering wheel 521 in the case where there is no control by the assist control unit 700. FIG. 6A is a Bode diagram illustrating a gain characteristic in the frequency characteristics. FIG. 6B is a Bode diagram illustrating a phase characteristic in the frequency characteristics. In FIG. 6A, the horizontal axis represents the frequency f [Hz], and the vertical axis represents the gain [dB]. In FIG. 6B, the horizontal axis represents the frequency f [Hz], and the vertical axis represents the phase [deg].

In FIG. 6A, a gain curve G2a and a gain curve G2b are illustrated. The gain curve G2a indicates a gain characteristic in the case where the arm of the steering person is in a relaxed state. The gain curve G2b indicates a gain characteristic in the case where the arm of the steering person is in a tense state. FIG. 6B illustrates a phase curve P2a and a phase curve P2b. The phase curve P2a indicates a phase characteristic when the arm of the steer is in a relaxed state. The phase curve P2b indicates a phase characteristic when the arm of the steer is in a tense state. For example, the arm of the steering person becomes a relaxed state when the vehicle V travels straight, and becomes a tense state when the vehicle V turns a curve. The steering torque Tₕ is relatively small when the vehicle V travels straight, and the steering torque Tₕ becomes relatively large when the vehicle V turns a curve. For example, the steering person unconsciously steers the steering wheel 521 so that the frequency characteristics of the steering angle θₕ and the steering torque Tₕ become the frequency characteristics illustrated in FIGS. 6A and 6B.

As indicated by the gain curve G2a in FIG. 6A, when the vehicle V is caused to travel straight, for example, the steering person steers the steering wheel 521 such that the gain is increased up to a relatively low frequency F1 to enhance the output responsiveness, and the gain is decreased in a frequency band larger than the frequency F1. The frequency F1 is, for example, 0.3 Hz. As indicated by the gain curve G2a in FIG. 6A and the phase curve P2a in FIG. 6B, when the vehicle V is caused to travel straight, the steering person steers the steering wheel 521 so as to have a pole near a frequency F2, for example. The frequency F2 is, for example, 1.0 Hz.

As indicated by the gain curve G2b in FIG. 6A, when the vehicle V is curved, the steering person decreases the gain in all frequency bands to improve the output stability, for example. As indicated by gain curve G2b in FIG. 6A and phase curve P2b in FIG. 6B, when the vehicle V is curved, the steering person operates the steering wheel 521 so as to have a pole near a frequency F3, for example. The frequency F3 is higher than the frequency F2. The frequency F3 is, for example, 4.0 Hz.

Here, the resonance frequency Fr of the shake in the left-right direction (yaw direction) of the vehicle V is, for example, about 1.5 Hz. The resonance frequency Fr is higher than the frequency F2 and lower than the frequency F3. The resonance frequency Fr may be different for each vehicle V, for example, and is not particularly limited. When the change in phase is large in the vicinity of the resonance frequency Fr in the frequency characteristics of the steering angle θₕ and the steering torque Tₕ, the vehicle V tends to resonate, and the vehicle V swings in the left-right direction and the traveling tends to be unstable. On the other hand, as described above, the steering person unconsciously shifts the frequency band in which the phase greatly changes with respect to the resonance frequency Fr (1.5 Hz) by setting the pole in the frequency characteristic of the steering angle θₕ and the steering torque Tₕ to be around 1.0 Hz when the vehicle V travels straight, and setting the pole in the frequency characteristic of the steering angle θₕ and the steering torque Tₕ to be around 4.0 Hz when the vehicle V curves. As a result, the steering person unconsciously causes the vehicle V to stably travel. In the present embodiment, the resonance frequency Fr corresponds to a “second frequency” obtained based on the vehicle characteristics based on the relationship between the steering angle θₕ and the yaw rate Y indicating the change in the yaw angle φ of the vehicle V on which the steering mechanism 530 is mounted.

As described above, when there is no control by the assist control unit 700, the steering person unconsciously changes the frequency characteristic of the arm to steer the steering wheel 521. Here, the stiffness of the arm in a state where the arm of the steering person is tense is larger than the stiffness of the arm in a state where the arm of the steering person is in a relaxed state. That is, when there is no control by the assist control unit 700, the steering person unconsciously changes the rigidity of the arm to steer the steering wheel 521. In the lane keeping control, the assist control unit 700 of the present embodiment generates the instruction torque Tᵣ in consideration of the characteristic that the steering person who steers the steering wheel 521 unconsciously adapts the rigidity of the arm. That is, the mechanical characteristic of the arm of the steering person taken into consideration by the assist control unit 700 in the present embodiment includes a characteristic that the steering person adapts the stiffness of the arm according to the state of the vehicle V.

In the present embodiment, the correction unit 620 corrects the target torque Tᵣ₂ in consideration of the frequency characteristics illustrated in FIGS. 6A and 6B, thereby bringing the instruction torque Tᵣ input to the motor 543 close to the steering torque Tₕ input to the steering wheel 521 by the steering person when there is no control by the assist control unit 700. As a result, when the lane keeping control is executed by the assist control unit 700, it is possible to reduce the sense of discomfort felt by the steering person from the steering wheel 521. In the present embodiment, the transfer function C(s) of the correction unit 620 is expressed by the following Expression [3].

$$[ Expression 3 ]$$

$$C ( s ) = \frac{as + b}{cs + d} \frac{1}{es + f} \qquad [ 3 ]$$

Where, s represents a Laplace transducer and a, b, c, d, e, and f represent coefficients relating to the mechanical characteristic of the arm of the steering person.

The right part of the above Expression [3], that is, 1/(es+f), reduces a predetermined frequency component of the target torque Tᵣ₂ input to the correction unit 620. In the present embodiment, 1/(es+f) in Expression [3] functions as a low-pass filter that reduces a frequency component higher than a first frequency obtained based on the mechanical characteristic of the arm of the steering person. The first frequency is determined based on the frequency band of an input applied to the steering wheel 521 when the steering person steers the steering wheel 521. The first frequency is, for example, the maximum value in the average frequency band of the input applied to the steering wheel 521 by the steering person. The first frequency is, for example, 0.5 Hz. That is, the average frequency of the input applied from the arm of the steering person to the steering wheel 521 is, for example, 0.5 Hz or less. 1/(es+f) in Expression [3] reduces a frequency component higher than the first frequency in the target torque Tᵣ₂, so that a frequency component that is not applied to the steering wheel 521 from the arm of the steering person or a frequency component that is hardly applied is reduced from the target torque Tᵣ₂. As a result, the instruction torque Tᵣ obtained based on the target torque Tᵣ₂ can be brought close to the steering torque Tₕ applied from the arm of the steering person to the steering wheel 521 in a case where there is no control by the assist control unit 700. Therefore, when the lane keeping control is performed by the assist control unit 700, it is possible to make it difficult for the steering wheel 521 to take a behavior different from that when the steering person steers the steering wheel 521 without the assist control unit 700, and it is possible to reduce the sense of discomfort felt by the steering person from the steering wheel 521.

As described above, according to the present embodiment, the correction unit 620 reduces the predetermined frequency component of the target torque Tᵣ₂ on the basis of the mechanical characteristic of the arm of the steering person, whereby the sense of discomfort given to the steering person can be reduced in the lane keeping control. Further, in the present embodiment, the predetermined frequency component is a frequency component higher than the first frequency obtained based on the mechanical characteristic of the arm of the steering person, among the frequency components of the target torque Tᵣ₂. Therefore, the frequency component actually input to the steering wheel 521 from the steering person can be suitably extracted from the target torque Tᵣ₂ by the correction unit 620, and the sense of discomfort given to the steering person can be further reduced.

The coefficients e and f of 1/(es+f) in the above Expression [3] are determined based on the average frequency of the input applied to the steering wheel 521 from the arm of the steering person. When the average frequency does not change between the case where the vehicle V is caused to travel straight and the case where the vehicle V is caused to curve, the coefficients e and f are the same values in both the case where the vehicle V is caused to travel straight and the case where the vehicle V is caused to curve, for example. On the other hand, when the average frequency changes between when the vehicle V is caused to travel straight and when the vehicle V is caused to curve, the coefficients e and f may be different values between when the vehicle V is caused to travel straight and when the vehicle V is caused to curve, for example.

The left part of the above Expression [3], that is, (as +b)/(cs+d), changes the phase of the target torque Tᵣ₂ based on the mechanical characteristic of the arm of the steering person. More specifically, (as +b)/(cs+d) in Expression [3] changes the phase of the target torque Tᵣ₂ such that the change rate of the phase of the instruction torque Tᵣ with respect to the frequency becomes small at the resonance frequency Fr. Here, the change rate of the phase of the instruction torque Tr with respect to the frequency is a change amount of the phase in a case where the frequency changes by a unit amount, and is the magnitude of the inclination with respect to the horizontal axis in the Bode diagram indicating the phase characteristic of the instruction torque Tᵣ, that is, the axis indicating the frequency f.

In the example of the Bode diagram illustrated in FIG. 6B, it can be seen that the steering person shifts the position of the output pole with respect to the resonance frequency Fr, so that the inclination with respect to the horizontal axis of the phase curves P2a and P2b at the resonance frequency Fr, that is, the axis indicating the frequency f, is smaller than the inclination at each pole or the like. In (as +b)/(cs+d) in Expression [3], the phase of the target torque Tᵣ₂ is changed such that the change rate of the phase of the instruction torque Tᵣ with respect to the frequency becomes small at the resonance frequency Fr, whereby the adjustment similar to the output pole adjustment unconsciously performed by the steering person as illustrated in FIG. 6B is performed. As a result, it is possible to suppress resonance of the vehicle V.

In the present embodiment, (as +b)/(cs+d) in Expression [3] is a portion for performing phase advance compensation. By advancing the phase of the target torque Tᵣ₂ by (as +b)/(cs+d) in Expression [3], it is possible to shift the frequency band in which the phase greatly changes from the resonance frequency Fr, similarly to the operation unconsciously performed by the steering person described above. As a result, by (as +b)/(cs+d) in Expression [3], it is possible to perform the same operation as the above-described adjustment of the output pole performed unconsciously by the steering person. Therefore, the movement of the steering wheel 521 adjusted by the motor 543 when the lane keeping control is performed can be brought close to the movement of the steering wheel 521 steered by the steering person when the lane keeping control is not performed. As a result, it is possible to reduce the sense of discomfort felt by the steering person from the steering wheel 521 when the lane keeping control is performed.

As described above, according to the present embodiment, the correction unit 620 changes the phase of the target torque Tᵣ₂ on the basis of the mechanical characteristic of the arm of the steering person, whereby the sense of discomfort given to the steering person can be reduced in the lane keeping control. In addition, in the present embodiment, the correction unit 620 changes the phase of the target torque Tᵣ₂ so that the change rate of the phase of the instruction torque Tᵣ with respect to the frequency becomes small at the resonance frequency Fr, and thus, as described above, it is possible to more suitably reduce the uncomfortable feeling given to the steering person, to suppress the resonance of the vehicle V, and to stably travel the vehicle V.

In the present embodiment, by setting the transfer function C(s) of the correction unit 620 to the transfer function expressed by the above-described Expression [3], the correction unit 620 can reduce a predetermined frequency component of the target torque Tᵣ₂ on the basis of the mechanical characteristic of the arm of the steering person, and change the phase of the target torque Tᵣ₂ on the basis of the mechanical characteristic of the arm of the steering person.

The coefficients a, b, c, and d of (as +b)/(cs+d) in the above Expression [3] are determined on the basis of how much the phase of the target torque Tᵣ₂ is advanced. For example, the coefficients a, b, c, and d are different values in a case where the vehicle V travels straight and in a case where the vehicle V curves. In this case, the vehicle characteristic compensation unit 610 may delay the phase of input target torque Tᵣ₁. That is, the phase of the target torque Tᵣ₂ output from the vehicle characteristic compensation unit 610 and input to the correction unit 620 may be delayed from the phase of the target torque Tᵣ₁ output from the imaging unit 400. In this case, by determining the coefficients a, b, c, and d on the basis of the magnitude of the phase delay caused by the vehicle characteristic compensation unit 610, the phase delay caused by the vehicle characteristic compensation unit 610 can be canceled, and the phase of the target torque Tᵣ₂ can be suitably shifted similarly to the case where the steering person unconsciously performs.

In the present embodiment, the coefficients a, b, c, and d of (as +b)/(cs+d) in Expression [3] have different values in a case where the vehicle V travels straight and in a case where the vehicle V curves. Therefore, the transfer function C(s) of the correction unit 620 is different in a case where the vehicle V travels straight and in a case where the vehicle V curves. Here, the steering torque Tₕ in a case where the vehicle V curves is larger than the steering torque Tₕ in a case where the vehicle V travels straight. That is, in the present embodiment, the transfer function C(s) of the correction unit 620 changes on the basis of the steering torque Tₕ. By changing the transfer function C(s) of the correction unit 620 on the basis of the steering torque Tₕ in this manner, the correction unit 620 can suitably correct the target torque Tᵣ₂ according to the traveling state of the vehicle V, and it is possible to suitably reduce the sense of discomfort given to the steering person regardless of the traveling state of the vehicle V.

The target torque Tᵣ₃ output from the correction unit 620 is input to the steering controller 630. The steering controller 630 generates the instruction torque Tᵣ on the basis of the input target torque Tᵣ₃, the current steering torque Tₕ detected by the steering torque sensor 541, the vehicle speed, and the like, and inputs the instruction torque Tᵣ to the motor 543. In the steering controller 630, for example, phase compensation, friction compensation, and the like that are performed during normal traveling are performed. As described above, the motor 543 is controlled based on the instruction torque Tᵣ generated by the assist control unit 700, so that the vehicle V is prevented from deviating from the lane L.

As described above, according to the present embodiment, the control device 100 that controls the steering mechanism 530 includes the assist control unit 700 that generates the instruction torque Tᵣ to be input to the motor 543. The assist control unit 700 generates the instruction torque Tᵣ in consideration of the mechanical characteristic of the arm of the steering person. Therefore, as described above, it is possible to reduce the sense of discomfort felt by the steering person on the arm due to the control of the assist control unit 700 as compared with the case where the motor 543 is controlled by the instruction torque Tᵣ generated simply in consideration of only the traveling of the vehicle V. Therefore, according to the control device 100 of the present embodiment, it is possible to reduce the sense of discomfort given to the arm of the steering person. In the present embodiment, the assist control unit 700 generates the instruction torque Tᵣ in consideration of the mechanical characteristic of the arm of the steering person in the lane keeping control. Therefore, when the lane keeping control is performed, it is possible to reduce the sense of discomfort given to the arm of the steering person.

Here, for example, if highly accurate prediction including a lane relatively far away from the vehicle is performed by using a high-performance imaging device or the like, there is a possibility that control for reducing the sense of discomfort given to the arm of the steering person can be realized. However, in that case, the manufacturing cost of the lane keeping system increases, and the calculation load in the lane keeping system also increases. On the other hand, as in the present embodiment, by performing correction in consideration of the mechanical characteristic of the arm of the steering person, it is possible to reduce the sense of discomfort given to the arm of the steering person without performing highly accurate prediction including a lane relatively far away from the vehicle. Therefore, the performance of the imaging device 410 can be lowered to some extent, and an increase in the manufacturing cost of the lane keeping system 1100 can be suppressed. In addition, the calculation load of the lane keeping system 1100 can be reduced. In addition, since the lane keeping control is performed while reducing the sense of discomfort of the arm from the viewpoint of the steering person, it is possible to obtain the steering feeling equivalent to the case where the highly accurate prediction as described above is performed.

According to the present embodiment, as described above, the assist control unit 700 generates the instruction torque Tᵣ in consideration of the mechanical characteristic of the arm of the steering person by performing correction by the correction unit 620 in the lane keeping control. Therefore, the instruction torque Tᵣ obtained in the conventional lane keeping control is corrected by the correction unit 620 in consideration of the mechanical characteristic of the arm of the steering person, so that the sense of discomfort given to the arm of the steering person can be suitably reduced. In the present embodiment, the correction unit 620 corrects the target torque Tᵣ₂ obtained on the basis of a signal from the imaging device 410 that images the lane L. Therefore, it is possible to reduce the sense of discomfort given to the arm of the steering person while suitably performing the lane keeping control based on the signal from the imaging device 410.

As described above, in the present embodiment, the correction unit 620 reduces the predetermined frequency component of the target torque Tᵣ₂ on the basis of the frequency band of the input applied from the arm of the steering person to the steering wheel 521, and changes the phase of the target torque Tᵣ₂ on the basis of the phase characteristic of the input applied from the arm of the steering person to the steering wheel 521, thereby performing correction in consideration of the mechanical characteristic of the arm of the steering person. As a result, the assist control unit 700 generates the instruction torque Tᵣ in consideration of the mechanical characteristic of the arm of the steering person.

According to the present embodiment, the assist control unit 700 generates the instruction torque Tᵣ in consideration of the vehicle characteristics based on the relationship between the steering angle θₕ and the yaw rate Y indicating the change in the yaw angle φ of the vehicle V in the lane keeping control. Therefore, it is possible to suppress the traveling of the vehicle V from becoming unstable by the control of the motor 543 based on the instruction torque Tᵣ. Specifically, in the present embodiment, since the assist control unit 700 includes the vehicle characteristic compensation unit 610 that compensates for the vehicle characteristics, the vehicle characteristics illustrated in FIGS. 5A and 5B can be canceled. As a result, it is possible to cancel the pole in the vehicle characteristics illustrated in FIGS. 5A and 5B. The pole in the vehicle characteristics is a point at which the frequency f becomes the resonance frequency Fr. Therefore, resonance of the vehicle V can be further suppressed, and traveling of the vehicle V can be further stabilized. As described above, the transfer function Pₙ⁻¹(s) of the vehicle characteristic compensation unit 610 is expressed by Expression [2]. By setting the transfer function Pₙ⁻¹(s) of the vehicle characteristic compensation unit 610 to such a transfer function, the vehicle characteristics can be suitably canceled.

As described above, the transfer function P(s) of the vehicle characteristics changes depending on the speed of the vehicle V. On the other hand, according to the present embodiment, the transfer function Pₙ⁻¹(s) of the vehicle characteristic compensation unit 610 changes based on the speed of the vehicle V. Therefore, even if the transfer function P(s) of the vehicle characteristic changes when the speed of the vehicle V changes, the vehicle characteristic can be suitably canceled by the vehicle characteristic compensation unit 610. As a result, the traveling of the vehicle V can be further stabilized regardless of the speed of the vehicle V.

### Second Embodiment

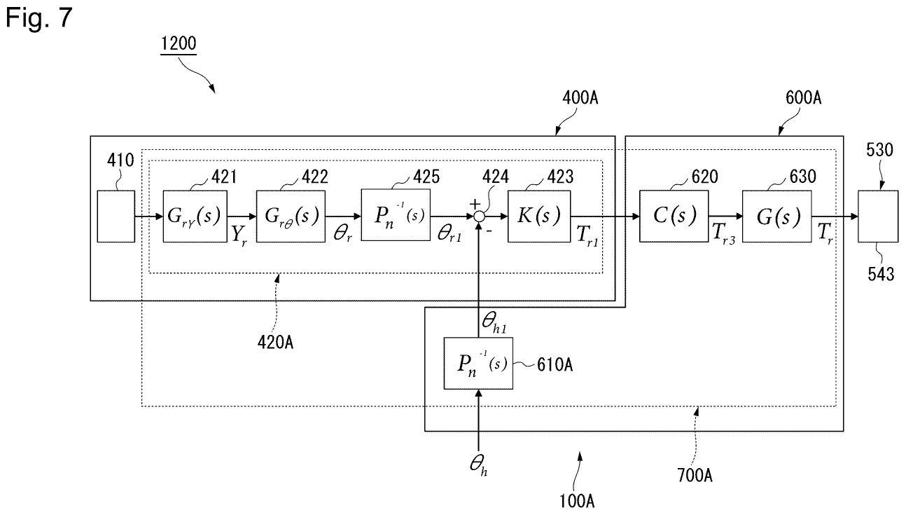

In the following description, configurations similar to those of the above-described embodiments may be denoted by the identical reference numerals as appropriate, and description may be omitted. As illustrated in FIG. 7, in a control device 100A of a lane keeping system 1200 according to the present embodiment, a vehicle characteristic compensation unit of an assist control unit 700A includes a first vehicle characteristic compensation unit 610A and a second vehicle characteristic compensation unit 425. The first vehicle characteristic compensation unit 610A is provided in a steering control unit 600A. The second vehicle characteristic compensation unit 425 is provided in an imaging device controller 420A of an imaging unit 400A. The transfer function Pₙ⁻¹(s) of the first vehicle characteristic compensation unit 610A and the transfer function Pₙ⁻¹(s) of the second vehicle characteristic compensation unit 425 are the same as each other, and are, for example, the same as the transfer function Pₙ⁻¹(s) of the vehicle characteristic compensation unit 610 of the first embodiment described above.

The current steering angle θₕ is input to the first vehicle characteristic compensation unit 610A. The first vehicle characteristic compensation unit 610A performs correction for compensating the vehicle characteristic with respect to the input steering angle θₕ, and outputs corrected steering angle θₕ to the subtractor 424 as a steering angle θₕ₁.

The target steering angle θᵣ output from the steering angle calculation unit 422 is input to the second vehicle characteristic compensation unit 425. That is, the target steering angle θᵣ obtained based on the signal from the imaging device 410 that images the lane L is input to the second vehicle characteristic compensation unit 425. The second vehicle characteristic compensation unit 425 performs correction for compensating the vehicle characteristic with respect to the input target steering angle θᵣ, and outputs the corrected target steering angle θᵣ to the subtractor 424 as the target steering angle θᵣ₁.

In the present embodiment, the subtractor 424 subtracts the steering angle θₕ₁ output from the first vehicle characteristic compensation unit 610A from the target steering angle θᵣ₁ output from the second vehicle characteristic compensation unit 425. In the present embodiment, the torque calculation unit 423 calculates the required target torque Tᵣ₁ based on the difference between the target steering angle θᵣ₁ and the steering angle θₕ₁ input from the subtractor 424. In the present embodiment, the target torque Tᵣ₁ output from the torque calculation unit 423 of the imaging unit 400A is directly input to the correction unit 620 without passing through the first vehicle characteristic compensation unit 610A. The correction unit 620 corrects the target torque Tᵣ₁ input from the imaging unit 400A and outputs the corrected target torque Tᵣ₁ to the steering controller 630 as the target torque Tᵣ₃. The steering controller 630 outputs the instruction torque Tᵣ to the motor 543. As described above, in the present embodiment, the assist control unit 700A generates the instruction torque Tᵣ based on the steering angle θₕ₁ output from the first vehicle characteristic compensation unit 610A and the target steering angle θᵣ₁ output from the second vehicle characteristic compensation unit 425 in the lane keeping control. The other configurations of the respective units of the lane keeping system 1200 are similar to the other configurations of the respective units of the lane keeping system 1100 of the first embodiment.

Even when the first vehicle characteristic compensation unit 610A and the second vehicle characteristic compensation unit 425 perform compensation to cancel the vehicle characteristics for the steering angle θₕ and the target steering angle θᵣ, respectively, as in the present embodiment, the same effects as those of the vehicle characteristic compensation unit 610 in the first embodiment can be obtained.

### Third Embodiment

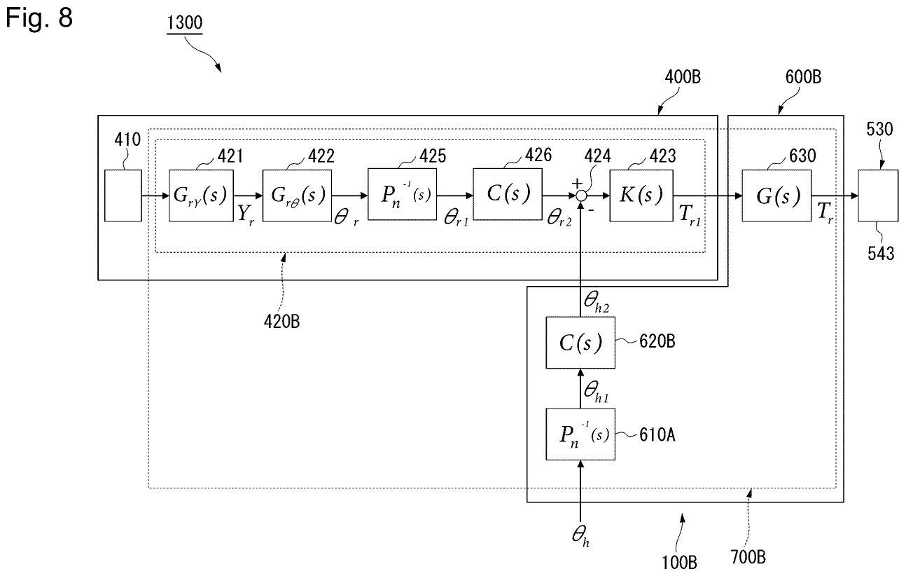

In the following description, configurations similar to those of the above-described embodiments may be denoted by the identical reference numerals as appropriate, and description may be omitted. As illustrated in FIG. 8, in a control device 100B of a lane keeping system 1300 of the present embodiment, a vehicle characteristic compensation unit of an assist control unit 700B includes the first vehicle characteristic compensation unit 610A and a second vehicle characteristic compensation unit 425 as in the second embodiment.

In the present embodiment, the correction unit of the assist control unit 700B includes a first correction unit 620B and a second correction unit 426. The first correction unit 620B is provided in the steering control unit 600B. The second correction unit 426 is provided in an imaging device controller 420B of an imaging unit 400B. The transfer function C(s) of the first correction unit 620B and the transfer function C(s) of the second correction unit 426 are the same as each other, and are, for example, the same as the transfer function C(s) of the correction unit 620 of the first embodiment described above.

The steering angle θₕ₁ output from the first vehicle characteristic compensation unit 610A is input to the first correction unit 620B. The first correction unit 620B performs correction on the input steering angle θₕ₁ in consideration of the mechanical characteristic of the arm of the steering person, and outputs the corrected steering angle θₕ₁ to the subtractor 424 as a steering angle θₕ₂.

The target steering angle θᵣ₁ output from the second vehicle characteristic compensation unit 425 is input to the second correction unit 426. The second correction unit 426 corrects the input target steering angle θᵣ₁ in consideration of the mechanical characteristic of the arm of the steering person, and outputs the corrected target steering angle θᵣ₁ to the subtractor 424 as a target steering angle θᵣ₂.

In the present embodiment, the subtractor 424 subtracts the steering angle θₕ₂ output from the first correction unit 620B from the target steering angle θᵣ₂ output from the second correction unit 426. In the present embodiment, the torque calculation unit 423 calculates the required target torque Tᵣ₁ based on the difference between the target steering angle θᵣ₂ and the steering angle θₕ₂ input from the subtractor 424. In the present embodiment, the target torque Tᵣ₁ output from the torque calculation unit 423 is a value corrected by the correction by the first correction unit 620B and the second correction unit 426 in consideration of the mechanical characteristic of the arm of the steering person. That is, in the present embodiment, the first correction unit 620B and the second correction unit 426 correct the steering angle θₕ₁ and the target steering angle θᵣ₁ before being input to the torque calculation unit 423, respectively, so that the target torque Tᵣ₁ to be output from the torque calculation unit 423 can be set to a value corrected in consideration of the mechanical characteristic of the arm of the steering person.

In the present embodiment, the target torque Tᵣ₁ output from the torque calculation unit 423 is directly input to the steering controller 630. The steering controller 630 outputs the instruction torque Tᵣ to the motor 543 based on the target torque Tᵣ₁. As described above, in the present embodiment, the assist control unit 700B generates the instruction torque Tᵣ based on the steering angle θₕ₂ output from the first correction unit 620B and the target steering angle θᵣ₂ output from the second correction unit 426 in the lane keeping control. The other configurations of the respective units of the lane keeping system 1300 are similar to the other configurations of the respective units of the lane keeping system 1200 of the second embodiment.

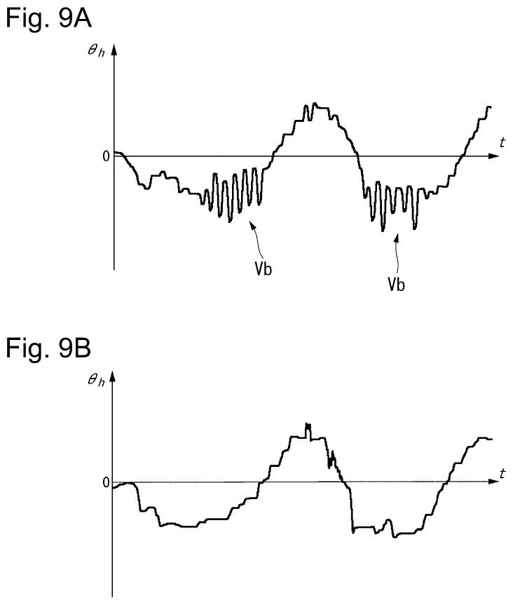

The present inventors confirmed the effects of the vehicle characteristic compensation unit described in the first embodiment, the second embodiment, and the third embodiment by performing actual vehicle measurement. The actual vehicle measurement was performed for each of the case where the vehicle characteristic compensation unit was not provided and the case where the vehicle characteristic compensation unit was provided. Each actual vehicle measurement was performed in a state where the steering person did not touch the steering wheel with a hand. FIG. 9A is a graph illustrating a result of actual vehicle measurement in the case where a vehicle characteristic compensation unit is not provided. FIG. 9B is a graph illustrating a result of actual vehicle measurement in the case where a vehicle characteristic compensation unit is provided. In FIGS. 9A and 9B, the horizontal axis represents time t, and the vertical axis represents the steering angle θₕ.

As illustrated in FIG. 9A, when a vehicle characteristic compensation unit is not provided, it can be confirmed that minute vibration Vb derived from the vehicle characteristic appears in the waveform of the steering angle θₕ. The vibration Vb is a vibration having a frequency near the resonance frequency Fr of the vehicle. On the other hand, as illustrated in FIG. 9B, when a vehicle characteristic compensation unit is provided to perform compensation for canceling the vehicle characteristic, it can be confirmed that the minute vibration Vb as illustrated in FIG. 9A does not appear in the waveform of the steering angle θₕ. As a result, it was confirmed that the vibration generated in the vehicle can be suppressed by providing a vehicle characteristic compensation unit.

The present invention is not limited to the above-described embodiment, and other configurations and other methods can be employed within the scope of the technical idea of the present invention. The assist control unit may generate the instruction torque in any manner as long as the instruction torque is generated in consideration of the mechanical characteristic of the arm of the steering person. The assist control unit may generate the instruction torque in consideration of the mechanical characteristic of the arm of the steering person in the control other than the lane keeping control. The transfer function of the correction unit that performs correction in consideration of the mechanical characteristic of the arm of the steering person is not particularly limited. The transfer function of the correction unit may be configured by only the portion of 1/(es+f) in the above-described Expression [3], or may be configured by only the portion of (as +b)/(cs+d) in the above-described Expression [3]. In addition, a correction unit in which the transfer function is 1/(es+f) in Expression [3] and a correction unit in which the transfer function is (as +b)/(cs+d) in Expression [3] may be separately provided.

In the case where the correction unit reduces a predetermined frequency component of the target torque on the basis of the mechanical characteristic of the arm of the steering person, the predetermined frequency component may be any frequency component as long as it is a frequency component determined on the basis of the mechanical characteristic of the arm of the steering person. When the correction unit changes the phase of the target torque based on the mechanical characteristic of the arm of the steer, the correction unit may change the phase of the target torque in any manner as long as the phase is changed based on the mechanical characteristic of the arm of the steer.

In each of the above-described embodiments, the assist control unit includes a part of the imaging unit and a part of the steering control unit, but the present invention is not limited thereto. The entire assist control unit may be provided in the imaging unit, or the entire assist control unit may be provided in the steering control unit. The transfer function of the vehicle characteristic compensation unit may be any transfer function as long as at least a part of the vehicle characteristic can be compensated. The vehicle characteristic compensation unit may not be provided. The control device having the assist control unit may be mounted in a system other than the lane keeping system as long as the control device has a motor and controls a steering mechanism mounted on the vehicle.

### EXAMPLE

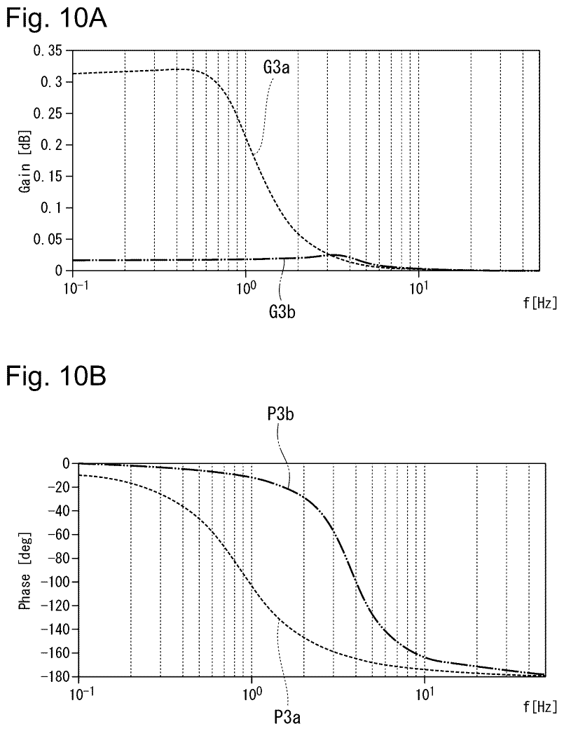

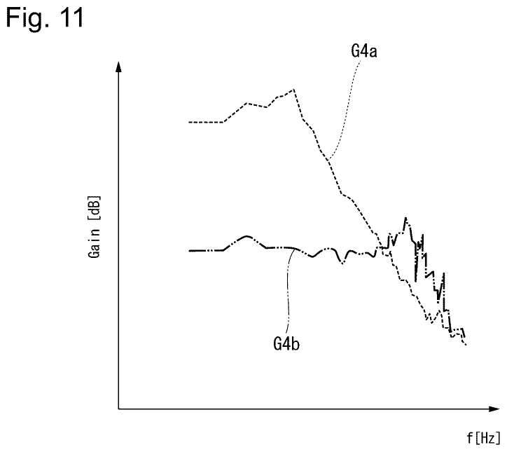

FIGS. 10A and 10B are graphs illustrating frequency characteristics of a steering angle and a steering torque in an example of the first embodiment described above. FIG. 10A is a Bode diagram illustrating a gain characteristic in the frequency characteristics of the example. FIG. 10B is a Bode diagram illustrating a phase characteristic in the frequency characteristics of the example. In FIG. 10A, the horizontal axis represents the frequency f [Hz], and the vertical axis represents the gain [dB]. In FIG. 10B, the horizontal axis represents the frequency f [Hz], and the vertical axis represents the phase [deg].

In the example, each parameter of the transfer function C(s) changes between when the vehicle travels straight and when the vehicle turns a curve. In FIG. 10A, a gain curve G3a indicates a gain characteristic when the vehicle travels straight in the example. In FIG. 10A, a gain curve G3b indicates a gain characteristic when the vehicle turns a curve in the example. In FIG. 10B, a phase curve P3a indicates a phase characteristic when the vehicle travels straight in the example. In FIG. 10B, a phase curve P3b indicates a phase characteristic when the vehicle turns a curve in the example.

The frequency characteristics illustrated in FIGS. 10A and 10B are frequency characteristics obtained by determining the parameter of the transfer function C(s) of the correction unit for each traveling state of the vehicle, on the basis of the frequency characteristics of the steering angle and the steering torque when the steering person actually steers the steering wheel without the control by the assist control unit. Specifically, the frequency characteristics of the example illustrated in FIGS. 10A and 10B are the same frequency characteristics as the frequency characteristics obtained from the average value of the results of actually measuring the driving of the steering person a plurality of times. That is, the frequency characteristics in the example can be obtained by adjusting each parameter of the transfer function C(s) such that the frequency characteristics are the same as the frequency characteristics obtained from the average value of the results of actually measuring the driving of the steering person a plurality of times. By determining the transfer function C(s) of the correction unit in this manner, it is possible to realize the same control as the control to adapt the stiffness of the arm actually performed unconsciously by the steering person in the absence of the control by the assist control unit, by the correction unit. This makes it possible to suitably reduce the sense of discomfort given to the steering person.

For example, the parameter of the transfer function C(s) of the correction unit may be determined such that the frequency characteristic of the embodiment is different from the frequency characteristic, on the basis of the frequency characteristic obtained from the average value of the results of actually measuring the driving of the steering person a plurality of times. Even in this case, it is possible to reduce the sense of discomfort given to the steering person. In the following example, description will be given on the assumption that the gain curve in FIG. 10A is a gain curve obtained by actually measuring the driving of the steering person, and the phase curve in FIG. 10B is a phase curve obtained by actually measuring the driving of the steering person.

For example, on the basis of the phase curve P3a in FIG. 10B, the pole of the phase curve when the vehicle in the example travels straight may be determined within a range of 0.8 Hz or more and 1.0 Hz or less, and the parameter of the transfer function C(s) may be determined such that the pole of the phase curve has the determined value. The pole of the phase curve in this case corresponds to the frequency F2 described in the first embodiment. Further, for example, based on the phase curve P3b in FIG. 10B, the pole of the phase curve when the vehicle turns the curve in the example may be determined within a range of 3.5 Hz or more and 4.5 Hz or less, and the parameter of the transfer function C(s) may be determined so that the pole of the phase curve has the determined value. The pole of the phase curve in this case corresponds to the frequency F3 described in the first embodiment. As a result, even if the frequency characteristic in the example is not completely the same as the frequency characteristic of the actual measurement value, the pole of the phase curve can be shifted with respect to the resonance frequency of the vehicle in the same manner as the steering person unconsciously performs. This makes it possible to reduce the sense of discomfort given to the steering person.

The pole of the phase curve P3a in FIG. 10B is 1.0 Hz, and the pole of the phase curve P3b is 4.0 Hz. Therefore, in the example, it is more preferable to determine the transfer function C(s) of the correction unit so that the pole of the phase curve when the vehicle is traveling straight is 1.0 Hz and the pole of the phase curve when the vehicle turns a curve is 4.0 Hz.

In addition, for example, based on the gain curve G3a in FIG. 10A, it may be determined to what degree of frequency the gain is to be increased when the vehicle travels straight in the example. The frequency corresponds to the frequency F1 described in the first embodiment. In the gain curve G3a in FIG. 10A, the gain increases with an increase in frequency up to around 0.4 Hz, and the gain decreases with an increase in frequency at around 0.4 Hz or more. Therefore, in the gain characteristic when the vehicle travels straight in the example, the parameter of the transfer function C(s) of the correction unit may be determined such that the gain is relatively large in the frequency band of 0.4 Hz or less and the gain is relatively small in the frequency band higher than 0.4 Hz. In this case, similarly to the case where the steering person unconsciously performs, it is possible to easily ensure the stability in a range where the frequency is relatively high while improving responsiveness in a range where the frequency is relatively low. This makes it possible to reduce the sense of discomfort given to the steering person.

Note that the present technique can have the following configurations.

(1) A control device that includes a motor and controls a steering mechanism mounted on a vehicle, the control device comprising an assist control unit that generates an instruction torque to be input to the motor, wherein the assist control unit generates the instruction torque in consideration of a mechanical characteristic of an arm of a steering person.

(2) The control device according to (1), wherein the mechanical characteristic of the arm of the steering person includes a characteristic that the steering person adapts rigidity of the arm according to a state of the vehicle.

(3) The control device according to (1) or (2), wherein the assist control unit is capable of executing lane keeping control for generating the instruction torque so as to keep the vehicle on which the steering mechanism is mounted in a lane, and generates the instruction torque in consideration of the mechanical characteristic of the arm of the steering person at least in the lane keeping control.

(4) The control device according to (3), wherein the assist control unit includes a correction unit that performs correction in consideration of the mechanical characteristic of the arm of the steering person, and generates the instruction torque in consideration of the mechanical characteristic of the arm of the steering person by performing correction by the correction unit in the lane keeping control.

(5) The control device according to (4), wherein the correction unit corrects a target torque obtained on a basis of a signal from an imaging device that images the lane.

(6) The control device according to (5), wherein the correction unit reduces a predetermined frequency component of the target torque on a basis of the mechanical characteristic of the arm of the steering person.

(7) The control device according to (6), wherein the predetermined frequency component is a frequency component higher than a first frequency obtained on the basis of the mechanical characteristic of the arm of the steering person, among frequency components of the target torque.

(8) The control device according to any one of (5) to (7), wherein the correction unit changes a phase of the target torque on the basis of the mechanical characteristic of the arm of the steering person.

(9) The control device according to (8), wherein the correction unit changes the phase of the target torque such that a change rate of a phase of the instruction torque with respect to a frequency decreases at a second frequency obtained on a basis of a vehicle characteristic based on a relationship between a steering angle and a yaw rate indicating a change in a yaw angle of the vehicle on which the steering mechanism is mounted.

(10) The control device according to any one of (4) to (9), wherein a transfer function C(s) of the correction unit is expressed by a following expression:

$$[ Expression 4 ]$$

$$C ( s ) = \frac{as + b}{cs + d} \frac{1}{es + f}$$

where, s represents a Laplace transducer and a, b, c, d, e, and f represent coefficients relating to the mechanical characteristic of the arm of the steering person.

(11) The control device according to any one of (4) to (10), wherein the transfer function of the correction unit changes based on a steering torque.

(12) The control device according to any one of (3) to (11), wherein the assist control unit generates the instruction torque in consideration of a vehicle characteristic based on a relationship between a steering angle and a yaw rate indicating a change in a yaw angle of the vehicle on which the steering mechanism is mounted in the lane keeping control.

(13) The control device according to (12), wherein the assist control unit includes a vehicle characteristic compensation unit that compensates for the vehicle characteristic.

(14) The control device according to (13), wherein the vehicle characteristic is a transmission characteristic when the steering angle is input and the yaw rate is output, and a transfer function Pₙ⁻¹(s) of the vehicle characteristic compensation unit is expressed by a following expression:

$$[ Expression 5 ]$$

$${P}_{n}^{- 1} ( s ) = \frac{{k}_{n} {s}^{2} + {m}_{n} s + {r}_{n}}{{g}_{n} s + {h}_{n}}$$

where, s represents a Laplace transducer, and gₙ, hₙ, kₙ, mₙ, and rₙ represent coefficients relating to the vehicle characteristic.

(15) The control device according to (13) or (14), wherein the transfer function of the vehicle characteristic compensation unit changes based on a speed of the vehicle.

(16) The control device according to any one of (13) to (15), wherein the vehicle characteristic compensation unit includes a first vehicle characteristic compensation unit and a second vehicle characteristic compensation unit, a steering angle is input to the first vehicle characteristic compensation unit, a target steering angle obtained based on a signal from an imaging device that images the lane is input to the second vehicle characteristic compensation unit, and in the lane keeping control, the assist control unit generates the instruction torque on a basis of the steering angle output from the first vehicle characteristic compensation unit and the target steering angle output from the second vehicle characteristic compensation unit.

(17) A lane keeping system comprising: an imaging device that images a lane; and the control device according to any one of (3) to (16).

The configurations and the methods described above in the present description can be combined as appropriate within a scope in which no mutual contradiction arises.

### REFERENCE SIGNS LIST

100, 100A, 100B control device
410 imaging device
425 second vehicle characteristic compensation unit (vehicle characteristic compensation unit)
426 second correction unit (correction unit)
530 steering mechanism
543 motor
610 vehicle characteristic compensation unit
610A first vehicle characteristic compensation unit (vehicle characteristic compensation unit)
620 correction unit
620B first correction unit (correction unit)
700, 700A, 700B assist control unit
1100, 1200, 1300 lane keeping system
Fr resonance frequency (second frequency)
L lane
Tₕ steering torque
Tᵣ instruction torque
Tᵣ₁, Tᵣ₂ target torque
V vehicle
Y yaw rate
θₕ, θₕ₁, θₕ₂ steering angle
θᵣ, θᵣ₁, θᵣ₂ target steering angle
φ yaw angle

1-17. (canceled)

18: A control device to control a steering mechanism mounted on a vehicle, the control device comprising:
a motor; and
an assist controller to generate an instruction torque to be input to the motor in consideration of a mechanical characteristic of an arm of a steering operator.

19: The control device according to claim 18, wherein the mechanical characteristic of the arm of the steering operator includes a characteristic that the steering operator adapts a rigidity of the arm according to a state of the vehicle.

20: The control device according to claim 18, wherein the assist controller is configured or programmed to execute lane keeping control to generate the instruction torque so as to keep the vehicle on which the steering mechanism is mounted in a lane, and generate the instruction torque in consideration of the mechanical characteristic of the arm of the steering operator at least in the lane keeping control.

21: The control device according to claim 20, wherein the assist controller is configured or programmed to include a corrector to perform correction in consideration of the mechanical characteristic of the arm of the steering person, and to generate the instruction torque in consideration of the mechanical characteristic of the arm of the steering operator by performing correction by the corrector in the lane keeping control.

22: The control device according to claim 21, wherein the corrector is configured or programmed to correct a target torque obtained on a basis of a signal from an imaging device that images the lane.

23: The control device according to claim 22, wherein the corrector is configured or programmed to reduce a predetermined frequency component of the target torque on a basis of the mechanical characteristic of the arm of the steering operator.

24: The control device according to claim 23, wherein the predetermined frequency component is a frequency component higher than a first frequency obtained based on the mechanical characteristic of the arm of the steering operator, among frequency components of the target torque.

25: The control device according to claim 22, wherein the corrector is configured or programmed to change a phase of the target torque based on the mechanical characteristic of the arm of the steering operator.

26: The control device according to claim 25, wherein the corrector is configured or programmed to change the phase of the target torque such that a change rate of a phase of the instruction torque with respect to a frequency decreases at a second frequency obtained on a basis of a vehicle characteristic based on a relationship between a steering angle and a yaw rate indicating a change in a yaw angle of the vehicle on which the steering mechanism is mounted.

27: The control device according to claim 21, wherein a transfer function C(s) of the corrector is expressed by:
$$C ( s ) = \frac{as + b}{cs + d} \frac{1}{es + f}$$
where, s represents a Laplace transducer, and a, b, c, d, e, and f represent coefficients relating to the mechanical characteristic of the arm of the steering operator.

28: The control device according to claim 21, wherein a transfer function of the corrector changes based on a steering torque.

29: The control device according to claim 20, wherein the assist controller is configured or programmed to generate the instruction torque in consideration of a vehicle characteristic based on a relationship between a steering angle and a yaw rate indicating a change in a yaw angle of the vehicle on which the steering mechanism is mounted in the lane keeping control.

30: The control device according to claim 29, wherein the assist controller is configured or programmed to include a vehicle characteristic compensator to compensate for the vehicle characteristic.

31: The control device according to claim 30, wherein
the vehicle characteristic is a transmission characteristic when the steering angle is input and the yaw rate is output; and
a transfer function Pₙ−1(s) of the vehicle characteristic compensator is expressed by:
$${P}_{n}^{- 1} ( s ) = \frac{{k}_{n} {s}^{2} + {m}_{n} s + {r}_{n}}{{g}_{n} s + {h}_{n}}$$
where, s represents a Laplace transducer, and gn, hn, kn, mn, and rn represent coefficients relating to the vehicle characteristic.

32: The control device according to claim 30, wherein the transfer function of the vehicle characteristic compensator changes based on a speed of the vehicle.

33: The control device according to claim 30, wherein
the vehicle characteristic compensator is configured or programmed to include a first vehicle characteristic compensator and a second vehicle characteristic compensator;
a steering angle is input to the first vehicle characteristic compensator;
a target steering angle obtained based on a signal from an imaging device that images the lane is input to the second vehicle characteristic compensator; and
in the lane keeping control, the assist controller is configured or programmed to generate the instruction torque on a basis of the steering angle output from the first vehicle characteristic compensator and the target steering angle output from the second vehicle characteristic compensator.

34: A lane keeping system comprising:
an imaging device to image a lane; and
the control device according to claim 20.
